(19) United States
(12) Patent Application Publication
(10) Pub. No.: US 2002/0174431 A1
(43) Pub. Date: Nov. 21, 2002

(54) Method and system for receiving music related information via an internet connection

(76) Inventors: John Bowman, Union City, CA (US); Kevin T. Dexter, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/858,245

(22) Filed: May 15, 2001

(51) Int. Cl. H04N 5/445; G06F 3/00; G06F 13/00; H04M 11/00; H04N 7/16; H04B 1/18; G06F 17/00; G09G 5/00

(52) U.S. Cl. 725/47; 725/142; 379/101.01; 700/234; 455/154.1; 455/158.5; 345/721

(57) ABSTRACT

A method and a system for a radio listener or a television viewer to retrieve a stored broadcast segment, such a song title or a sound recording, upon receiving a transmitted broadcast segment. In one embodiment, a computer-implemented method and system facilitates retrieving a stored broadcast segment associated with a transmitted broadcast segment in response to a user inquiry, wherein the user inquiry references a time and a date of a broadcast and a station identifier of the transmitted broadcast segment. The user initiates the inquiry upon receiving the transmitted broadcast segment that interests the user. The method includes configuring a broadcast segment database with a plurality of stored broadcast segments associated with respective broadcast times, broadcast dates, station identifiers and identification information. A first bookmark is generated in response to the user inquiry, wherein the first bookmark includes information describing the time and date of broadcast and the station identifier from the user inquiry. The first bookmark is stored in association with a user identification code in a user database. The first stored broadcast segment, corresponding to the first bookmark, is retrieved from the broadcast segment database and transmitted to a user-selected destination.

### FIELD OF THE INVENTION

The present invention generally relates to retrieving broadcast programming information and more particularly to retrieving titles of songs and programs that are broadcast on local radio and television stations.

### BACKGROUND OF THE INVENTION

While listening to music or a program on a local radio station, there are times when a listener is interested in identifying the song or program that is currently being played or aired. The listener may not only be interested in the song title but may also be interested in acquiring the song's recording. However, the listener usually must wait for the song or program to finish before the radio announcer states the song title and artist or states the title of the program. Many times the radio announcer fails to state the song or program title or the listener does not have time to wait until the end of the broadcast to hear the song or program title.

Once the song or program title is announced, the listener either has to have a good memory or have a notepad readily available to record the information. This can be particularly cumbersome when the song is heard while driving a car or while exercising. Once the information is missed or forgotten it will take some time to retrieve again. Devices sold today by Sony® and Xenote® provide the listener with the convenience of “marking” the song or program in real time with a portable device. However, these devices digitally timestamp the time that the song or program was heard but do not identify the song. The listener must still invest in the timestamp hardware and must have an Internet-connected personal computer available to download the device driver software for the timestamp hardware.

With this system, the timestamp device must be connected to the personal computer terminal and synchronized with a web-based data processing system that retrieves the playlists and the local radio stations that were broadcasting at the time the listener entered the timestamp. The listener still has the task of scanning through multiple playlists of the various radio stations and must guess the title and/or artist of the song of interest. This process has been facilitated somewhat by providing music clips to help jog the listener's memory, however these systems still require the listener to heavily interact with a web-based database to search for the song title.

It is even more difficult to identify a radio or television broadcast program since most of these programs are not usually repeated as often as are songs. The timestamp devices described above also have the drawback of having limited memory storage space to timestamp songs. This drawback leaves the listener with undesirable options such as immediate downloads of previous timestamps or erasure of previous timestamps to free up memory space for current timestamps.

It would be highly desirable to have a method and a system for retrieving broadcast related information in real time and without requiring the user/listener to scan through broadcast programming playlists to find the interested song or program or program title.

A method and a system that address the aforementioned problems, as well as other related problems, are therefore desirable.

### SUMMARY OF THE INVENTION

The present invention is directed to addressing the above and other needs in connection with the automatic identification and/or retrieval of a sound recording retrieved in response to a user's inquiry. With the present approach, a listener subscribes to a service that, in response to an inquiry, sends the title of a sound recording played on a radio station to the subscriber's mobile communications device. The present approach also facilitates the acquisition or purchase of the identified sound recording or program.

According to one aspect of the invention, a computer-implemented method and system facilitates retrieving a stored broadcast segment associated with a transmitted broadcast segment in response to a user inquiry, wherein the user inquiry references a time and a date of a broadcast and a station identifier of the transmitted broadcast segment. The user initiates the inquiry upon receiving the transmitted broadcast segment that interests the user. The method includes configuring a broadcast segment database with a plurality of stored broadcast segments associated with respective broadcast times, broadcast dates, station identifiers and identification information. A first bookmark is generated in response to the user inquiry, wherein the first bookmark includes information describing the time and date of broadcast and the station identifier from the user inquiry. The first bookmark is stored in association with a user identification code in a user database. The first stored broadcast segment, corresponding to the first bookmark, is retrieved from the broadcast segment database and transmitted to a user-selected destination.

The above summary of the present invention is not intended to describe each illustrated embodiment or every implementation of the present invention. The figures in the detailed description that follow more particularly exemplify these embodiments.

### BRIEF DESCRIPTION OF THE DRAWINGS

Various aspects and advantages of the invention will become apparent upon review of the following detailed description and upon reference to the drawings in which:

FIG. 1 is a block diagram of a stored broadcast segment retrieval system configured in accordance with an example embodiment of the invention; and

FIG. 2 is a flowchart illustrating an example process of retrieving a selected stored broadcast segment from a broadcast segment database in accordance with an example embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention are described in terms of a stored broadcast segment retrieval system that enables a user to retrieve a stored broadcast segment, such as a sound recording, using a bookmark that includes the time and date of broadcast and the call sign of the station that played the stored broadcast segment. The stored broadcast segment is transmitted either to the user's mobile communication device or to a user-selected storage location. For purposes of this application, a broadcast segment includes, but is not limited to, titles of the following creative works as well as the creative works themselves: songs, a radio or television programs, movies or advertisements. Those skilled in the art will appreciate that the invention could be implemented in a variety of programming languages, computer platforms and communications systems.

In an example embodiment, a registered user of a stored broadcast segment retrieval system uses a mobile communications device, such as a mobile telephone, to obtain the title and/or the recording itself of a particular work heard on the radio. Hearing the song as a transmitted broadcast segment from a radio station prompts the user to seek the title and/or the song itself. In this example embodiment, the user retrieves the song by transmitting a bookmark from the mobile telephone to a vendor managed data processing system that uses the bookmark to retrieve the work. The work is stored in a broadcast segment database as a stored broadcast segment associated with identification information. The bookmark includes the time and date of broadcast and the radio station that played the song. In this example embodiment, a user identification code is appended to the bookmark transmission to generate demographic data for the vendor providing the retrieval service. The user identification code is assigned when the user completes a user profile in becoming a subscriber to the retrieval system. The retrieved work or song title is then transmitted to the user's mobile telephone or another user-selected destination.

In a related embodiment, the mobile communications device includes a receiver, for directly receiving radio and television broadcasts, and a digital sound recording arrangement for storing sound recordings that are downloaded directly to the mobile communications device. In this example embodiment, the bookmark is automatically generated when the user transmits the retrieval request. The receiver provides the tuned broadcast frequency, and an internal clock of the mobile device generates the time and date of the broadcast when the listener initiates a request. In another embodiment, the bookmark information from the mobile device is manually keyed into an Internet connected computer and the retrieval request is then transmitted to the vendor managed data processing system.

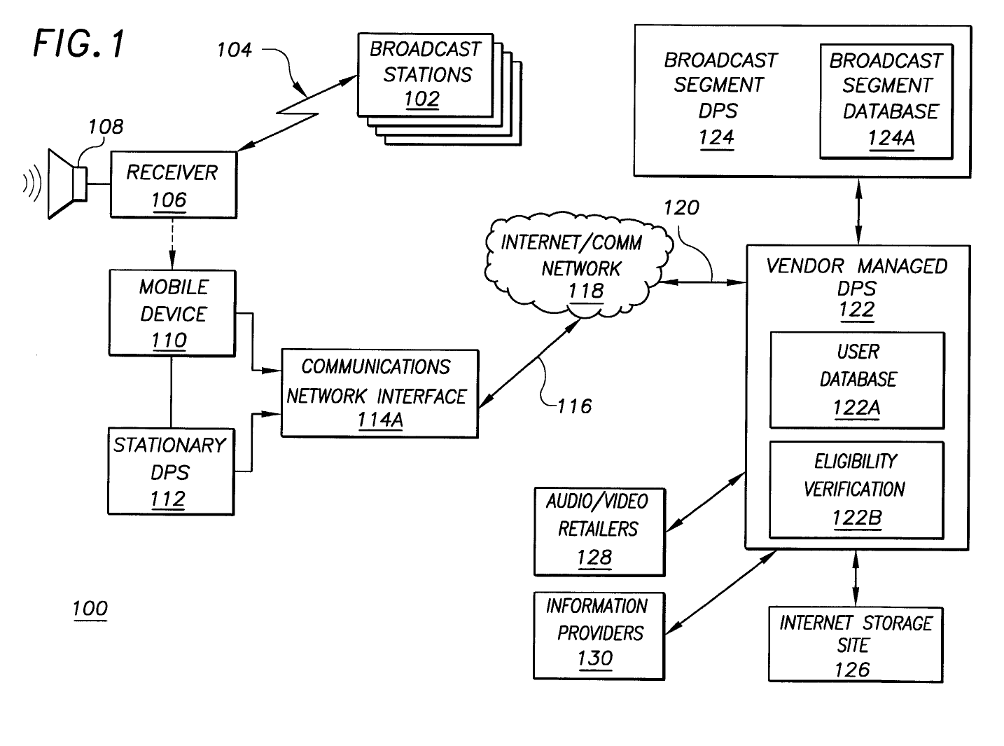

Referring now to the figures, FIG. 1 is a block diagram of a stored broadcast segment retrieval system 100 configured in accordance with an example embodiment of the invention. System 100 includes a plurality of broadcast stations 102 that broadcast music or programs via radio, television or satellite signals 104. Stations 102 typically broadcast locally under a call station sign (e.g., KQRS 92.5FM or KSTP-Ch. 5) or under a station identifier using their broadcast frequency (e.g., 105.1MHz). A receiver 106 receives transmitted broadcast segments from stations 102 in the form of radio, television or satellite signals 104. Receiver 106 decodes the signals and plays the transmitted broadcast segments through a speaker arrangement 108 that enables a listener to hear the song or program. In a related embodiment, speaker arrangement 108 includes a display or screen to view transmitted video signals that accompany the transmitted audio signals.

A listener that has just heard his favorite song via speaker 108, but is unable to remember the song title, uses the broadcast segment retrieval service to retrieve the song title and the sound recording. With the present approach, the listener (hereinafter user) “bookmarks” the song or program, using a wireless communications device or a personal computer, which digitally timestamps the song or program. The user sends the digital timestamp, which includes the date and time, and the station identifier to a remote data processing system for retrieval of the song or title of the program. The user then receives the information sought at the mobile device or computer.

In this example embodiment, the user accesses a vendor managed data processing system 122, using a mobile communications device 110 or a personal computer 112, that retrieves the stored broadcast segment (e.g., song title or sound recording) from a broadcast segment database 124A. In one embodiment, mobile device 110 includes a mobile telephone, a two-way pager, a PDA or similar two-way communications device. Displays coupled to these devices, useable to display responses from DPS 122, include CRT monitors, LCD displays, mobile and regular telephone displays and personal digital assistant displays. In another related embodiment, PDAs, enhanced mobile telephones, enhanced personal audio players with wireless communication and MP3 storage capabilities, and enhanced automotive navigational/communication systems combine receiver 106, speaker 108 and mobile device 110 capabilities into a single device.

Mobile device 110 and computer 112 access DPS 122 through a network interface 114 that is coupled to a communications network 118 (the Internet or the PSTN) via a communications channel 116 (traditional or wireless, for example). Device 110 and computer 112 are configured to download application software to access DPS 122. In this example embodiment, DPS 122 is a server having a user-selected database 122A and an eligibility verification database 122B. Vendor DPS 122 is coupled to a stored broadcast segment DPS 124 that includes a stored broadcast segment database 124A having a listing of station identifiers, playlists and broadcast schedules (i.e., broadcast times and dates). Vendor DPS 122 is also coupled to an Internet storage site 126 for storage of broadcast segments that will be retrieved by the user at a later time. Vendor DPS 122 is also coupled to an audio/video retailer(s) DPS 128 to facilitate purchases of music and videos. DPS 122 is also coupled to an information provider(s) DPS 130 to facilitate retrieval of in-depth information on music, programs or other creative works of interest.

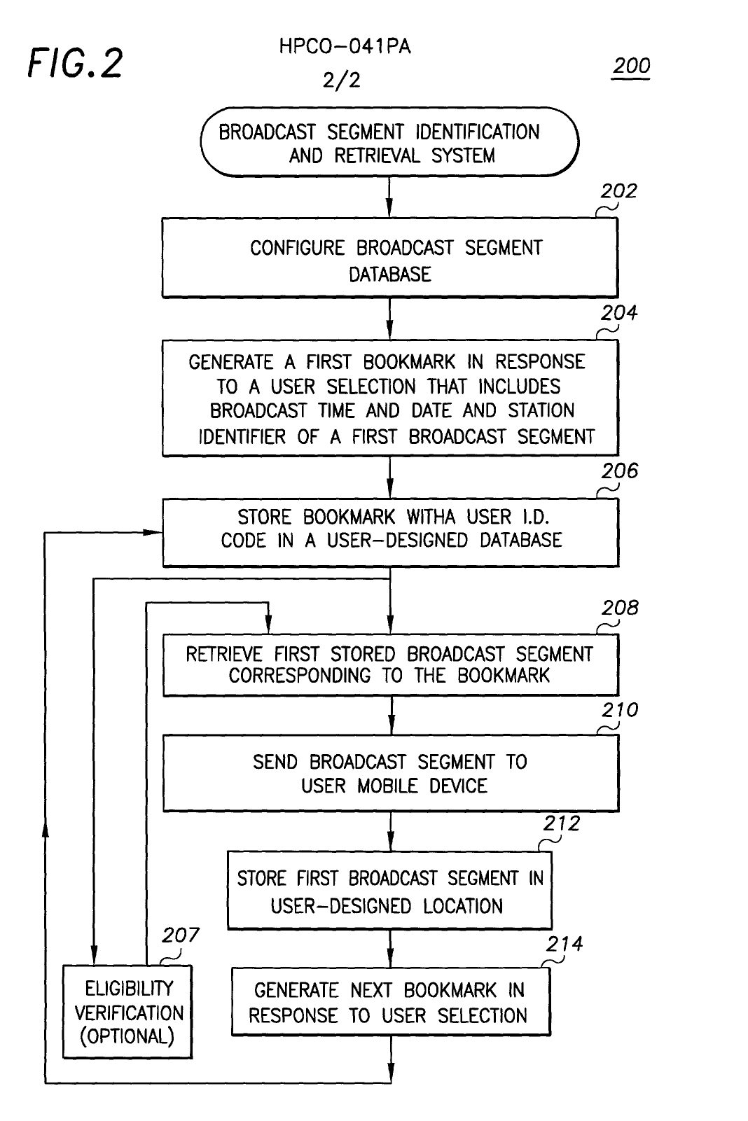

The present approach simplifies the process of purchasing the song by facilitating the connection to audio/video retailer DPS 128 after receiving the stored broadcast segment from DPS 124. The user benefits from using the present approach since the song title is automatically retrieved without undue searching and the vendor benefits since music purchases are facilitated for the user (prompting more purchases). Vendors also benefit since purchasing habits of users are gathered as demographic data following the user registration process (e.g., completing the user-profile, assigning a user ID code, etc.). The operation of system 100 will be described in more detail in connection with the discussion of FIG. 2.

Referring now to FIG. 2, a flowchart 200 illustrates an example process of retrieving a selected stored broadcast segment from a broadcast segment database in accordance with an example embodiment of the invention. At step 202, a broadcast segment database 124A is configured with information describing a plurality of stored broadcast segments, such as songs or radio programs. Each stored broadcast segment is associated with their respective broadcast times, broadcast dates and station identifiers within database 124A. One example of such a database is provided by Broadcast Data Systems (www.bdsonline.com), which provides the additional feature of digital music recognition. A user of the present system first downloads application software to mobile device 110 or computer 112. During the application download process, the user registers to use the retrieval service by completing a user-profile. The user also indicates the destination for responses from DPS 122, such as mobile device 110, computer 112 or Internet storage site 126. The user is then assigned the user identification code for accessing and navigating within DPS 122.

As the user is listening to a song of interest on the radio, at step 204, the user generates a digital timestamp (records broadcast date and time) by pressing a button on mobile device 110 that creates part of a first bookmark. The user completes the bookmark by using device 110 to key in the broadcast frequency or the station call sign of the radio station that played the song. In a related embodiment, the user selects the station call sign from a pre-configured listing of local stations displayed on a graphical user interface (GUI) of mobile device 110. The user then transmits the bookmark from mobile device 110 to vendor managed DPS 122 by pressing another button on device 110. In another example embodiment, the broadcast time and date, along with the station identifier, is manually keyed into computer 112. Computer 112 then transmits the bookmark to DPS 122 via network 118. In an example embodiment, the user ID code is automatically appended to the bookmark upon transmission to identify the origin of the bookmark. In another example embodiment, the bookmark and the user ID code are temporarily stored in device 110 (or computer 112) as the bookmark is transmitted to DPS 122.

At step 206, the bookmark is received by DPS 122 and stored in association with a user ID code in user-selected database 122A. In another example embodiment, at optional step 207, eligibility verification database 122B is reviewed to verify validity of the user ID code before the stored broadcast segment is retrieved. The user ID code is not only used to ensure that the user is registered with the identification service, but is also used to track retrieval requests for the user and to gather other demographic data to augment user profiles. At step 208, DPS 122 retrieves from broadcast segment database 124A the stored broadcast segment that corresponds to the bookmark. DPS 124 uses the digital timestamp of the bookmark as well as the station identifier to search within database 124A for the playlist of the station. In this example embodiment, at step 210 DPS 122 transmits the retrieved stored broadcast segment to mobile device 110 (i.e., user selected destination).

In another example embodiment, at step 212, the song title or sound recording is stored in either user-selected database 122A or Internet storage site 126 associated with the user ID code. The following are examples of Internet music storage sites that the user can use: myplay, X-drive or Netdrive. In this embodiment, the user retrieves the stored broadcast segment from site 126 at any time. In a related embodiment, the user is free to retrieve the song title or sound recording (i.e., stored broadcast segment), at a later time, by using the user ID code to access the database 122A via DPS 122. At step 214, the system is ready to process an additional bookmark that is sent by the same or another user. In another example embodiment, the user chooses at the initial set-up to have DPS 122 retrieve the actual song and not just the song title, as in step 210.

In another embodiment, the user receives at mobile device 110 (or computer 112) the song title along with a weblink to access audio/video retailer DPS 128 (e.g., Amazon.com, Sam Goody, etc.) for buying the sound recording. In the example embodiment involving the program title, the user receives the program title with a weblink to access information provider DPS 130 (e.g., muse.com) to obtain more information about the program. Where the song is stored in Internet site 126, the user retrieves the song by using the user ID code and compatible software (e.g., e-Music, liquidaudio, MP3.com, etc.). Depending on the instructions the user gives on the profile and the level of service the user requests (user chooses to prepay for unlimited music retrieval or pay for each song requested) dictates the type of response that the user will receive from DPS 122. In another example embodiment, the song identification service is provided for a basic user fee or for free by audio/video vendors (such as Amazon.com, Sam Goody or Blockbuster videos) to drive user traffic to their websites and to increase CD and video sales.

In another example embodiment, additional titles of other music collections (in the form of CDs, cassettes, records, etc.) from the same or similar artist are included with the stored broadcast segment sent to the user. A review by the user of the additional titles or sound recordings, by selecting a web link for purchase or additional information generates behavioral data that is stored in a behavioral database within DPS 122. With this approach, the vendors managing DPS 122 and DPS 128 learn more about the user's interests and the user learns more about what the vendor/retailer has to offer.

The present invention is believed to be available to users of personal computers, mobile telephone, PDAs, pagers and other digital communication devices that have the capability of downloading application software to access the described service. The present invention has been found to be particularly useful in reducing the time and effort a user spends in identifying and retrieving a desired song or program and in effecting its purchase. The present invention also has the advantage of incrementally developing a database on each user's broadcast programming interests without requiring the customer to regularly update the user profile. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A computer-implemented method for retrieving a stored broadcast segment associated with a transmitted broadcast segment in response to a user inquiry, the user inquiry referencing a time and a date of broadcast, and a station identifier of the transmitted broadcast segment, the user initiating the inquiry upon receiving the transmitted broadcast segment, the method comprising:
configuring a broadcast segment database with a plurality of stored broadcast segments associated with respective broadcast times, broadcast dates, station identifiers and identification information;
generating a first bookmark in response to the user inquiry, wherein the first bookmark includes information describing the time and date of broadcast and the station identifier from the user inquiry;
storing the first bookmark in association with a user identification code in a user database;
retrieving a first stored broadcast segment corresponding to the first bookmark from the broadcast segment database; and
transmitting the first stored broadcast segment to a user-selected destination.

2. The method of claim 1, further comprising after the transmitting step, storing the first stored broadcast segment in a user-selected storage location associated with the user identification code for subsequent retrieval and review by the user.

3. The method of claim 1, wherein the step of generating the first bookmark includes the steps of:
recording the time and date of broadcast of the transmitted broadcast segment with a mobile communications device upon entering the station identifier in the mobile communications device; and
transmitting the first bookmark from the mobile communications device to the user database.

4. The method of claim 1, wherein the first stored broadcast segment includes a title of a creative work, the creative work selected from the group consisting of: a sound recording, a video program and a movie.

5. The method of claim 4, further comprising after the transmitting step:
retrieving with a vendor managed data processing system the creative work corresponding to the title; and
storing the creative work in a user-selected storage location.

6. The method of claim 1, further comprising before generating the first bookmark:
assigning the user identification code upon completing a user-profile; and
generating a set of demographic data for each user when retrieving from the broadcast segment database.

7. The method of claim 6, further comprising the step of verifying eligibility of the user to retrieve the first stored broadcast segment from the broadcast segment database.

8. The method of claim 1, further comprising before generating the first bookmark:
configuring a communications device that is responsive to the user initiating the inquiry;
generating the time and date of broadcast of the transmitted broadcast segment with the communications device; and
selecting the station identifier of the transmitted broadcast segment from a stored list of station identifiers, wherein the stored list is stored in a memory arrangement of the communications device.

9. The method of claim 7, wherein the step of transmitting the first stored broadcast segment includes the step of configuring the mobile communications device as the user-selected destination.

10. A system for retrieving a stored broadcast segment associated with a transmitted broadcast segment in response to a user inquiry, the user inquiry referencing a time and a date of broadcast, and a station identifier of the transmitted broadcast segment, the user initiating the inquiry upon receiving the transmitted broadcast segment, the method comprising:
a broadcast segment database configured with a plurality of stored broadcast segments associated with respective broadcast times, broadcast dates, station identifiers and identification information;
means for generating a first bookmark in response to the user inquiry, wherein the first bookmark includes information describing the time and date of broadcast and the station identifier from the user inquiry;
means for storing the first bookmark in association with a user identification code in a user database;
means for retrieving a first stored broadcast segment corresponding to the first bookmark from the broadcast segment database; and
means for transmitting the first stored broadcast segment to a user-selected destination.

11. The system of claim 10, wherein means for generating a first bookmark includes a mobile communications device configured and arranged to store the time and date of the first broadcast segment upon entering the station identifier associated with the transmitted broadcast segment.

12. The system of claim 11, wherein the transmitted broadcast segment includes a creative work received by the user from a broadcast station associated with the station identifier, the creative work selected from the group consisting of: a sound recording, a video program and a movie.

13. The system of claim 11, wherein the stored broadcast segment includes a title of a creative work, the creative work selected from the group consisting of: a sound recording, a video program and a movie.

14. The system of claim 13, wherein means for retrieving the first stored broadcast segment includes a vendor managed data processing system configured to use the title to retrieve from the broadcast segment database the creative work associated with the title, the vendor managed data processing system further configured to transmit the creative work to the user-selected destination.

15. The system of claim 11, further comprising a user-profile database accessible by a vendor managed data processing system and configured to store a set of demographic data in association with the user identification code, the demographic data being generated as each user retrieves stored broadcast segments from the broadcast segment database.

16. The system of claim 11, the mobile communications device further comprising a receiver arrangement configured to receive and decode a signal that includes the transmitted broadcast segment that is transmitted at a selected radio frequency, wherein the mobile communications device is configured to store the time, date and selected radio frequency upon the user initiating the inquiry.

17. A computer-implemented method for retrieving a stored broadcast segment associated with a transmitted broadcast segment in response to a user inquiry, the user inquiry referencing a time and a date of broadcast, and a station identifier of the transmitted broadcast segment, the user initiating the inquiry upon receiving the transmitted broadcast segment, the method comprising:
configuring a broadcast segment database with a plurality of stored broadcast segments associated with respective broadcast times, broadcast dates, station identifiers and identification information;
generating a first bookmark in response to the user inquiry, wherein the first bookmark includes information describing the time and date of broadcast and the station identifier from the user inquiry;
storing the first bookmark in association with a user identification code in a user database;
retrieving a first stored broadcast segment corresponding to the first bookmark from the broadcast segment database;
retrieving a creative work corresponding to the first stored broadcast segment from a remote data processing system, wherein the creative work is a digital representation of a sound recording; and
transmitting the creative work to a mobile communications device and storing the creative work in a memory arrangement of the mobile communications device.
